(19) United States
(12) Patent Application Publication
(10) Pub. No.: US 2007/0221585 A1
(43) Pub. Date: Sep. 27, 2007

(54) Collapsible Protective Cover for a Filter

(76) Inventors: Andrea L. Vozar, Decatur, IL (US); Mark A. McElroy, Peoria, IL (US); Dana P. Heern, Lafayette, IN (US); Brian J. Earnhart, Zionsville, IN (US); Raymond G. Kulma, Lafayette, IN (US); Aaron O. Stritesky, Otsego, MN (US)

Correspondence Address: Caterpillar Inc.;Intellectual Property Dept., AB 6490, 100 N.E. Adams Street, PEORIA, IL, 61629-6490, US

(21) Appl. No.: 11/673,382

(22) Filed: Feb. 9, 2007

Related U.S. Application Data
(60) Provisional application No. 60/772,244, filed on Feb. 10, 2006.

(51) Int. Cl. C02F 1/00

(52) U.S. Cl. 210/767

(57) ABSTRACT

A collapsible, protective cover may be used to enshroud a filter during shipping, storage, and installation. The cover protects the filter from dirt and other harmful debris which could contaminate the clean filter element contained within the filter. As the filter is inserted into a filter canister, the cover collapses around the filter and moves out of the way, allowing the filter to enter the canister.

This application claims priority to U.S. provisional patent application Ser. No. 60/772,244 filed on Feb. 10, 2006.

### TECHNICAL FIELD

The field of this invention is the protection of filters against contamination.

### BACKGROUND

Canister filter systems are used extensively today on equipment such as internal combustion engines, construction and mining machinery, and many other types of industrial machinery. They are used to filter contaminants from fluid systems including fuel systems, lubrication oil systems, hydraulic fluid power systems, hydraulic fluid control systems, transmission fluid systems, air intake systems, and the like.

A canister filter system typically includes i) a base which is often attached to the equipment, ii) a canister (sometimes called a housing), and iii) a filter which is removably positioned inside the canister. After the filter is positioned inside the canister, the canister is attached to the base with threads or other attachment means to form a sealed compartment around the filter. The canister, base, and filter cooperate to define fluid passages through which fluid is directed through the filter. The filter contains filter media which traps and collects contaminants as the fluid passes through it. The contaminants which are trapped and collected in the filter media as the fluid passes through may include dirt, water, soot, ash, metallic particles, and other harmful debris.

Eventually these contaminants clog the filter media and reduce its effectiveness. Or other conditions can develop over time which also reduce the effectiveness of the filter media in removing contaminants. When this occurs, the filter media should be replaced or cleaned. Typically when the filter media is replaced, this is done by removing and replacing the entire filter with a new filter (i.e., typically the filter media is not removed from the filter and replaced, rather the whole filter is replaced with a new filter). But it is only the filter that need be replaced, while the canister, base, and any other components remain and are reused. The filter is designed to be conveniently replaced and readily disposable. The filter may be replaced periodically, according to the guidance of a maintenance schedule established for the particular application, to prevent the filter media from becoming too clogged.

Other types of filter systems include, for example, spin-on filters that are common on most personal automobiles. The spin-on filter typically includes a cylindrical, hard metal casing enclosing filter media. The hard metal casing is joined to an axial end cap on one end. The end cap typically has a threaded port which mates with a threaded post on a filter base attached to the automobile's engine.

Canister filter systems have many advantages over other filter systems such as spin-on filters. For example, maintaining a canister filter system may be less expensive than maintaining a comparable spin-on filter system. This is because the parts replaced during maintenance of a canister filter system can be less expensive than the parts replaced during maintenance of a spin-on filter system. When the filter media requires replacement in a canister filter system, only the filter needs to be removed and replaced with a new filter, whereas in a spin-on filter the entire assembly, including the hard metal casing and the axial end cap, must be removed and replaced. Also, disposal of the filter in a canister filter system may be simpler than disposal of a spin-on filter. This is because a canister filter can often be constructed from only two types of material: plastic and the filter media. This makes the filter relatively easy to dispose of or recycle. In contrast, a spin-on filter includes a metal casing and axial end cap in addition to the filter media and other components. The mix of materials in a spin-on filter can make disposal more complicated.

Detracting from its many advantages, canister filter systems do have at least one disadvantage which has been a motivating force for the development of this invention. Filters in canister filter systems often leave the filter media exposed to the outside environment prior to installation. In contrast, spin-on filters are typically relatively protected by their hard, impervious outside casing, so there is less risk that the filter media will be contaminated by the outside environment prior to installation.

Thus, the filter of a canister filter system may be susceptible to contamination prior to installation. If dirt or other debris contaminate the filter media prior to installation, then after installation these contaminants may make their way into and contaminate the fluid system that the filter was intended to protect. As a result, when replacing a filter in a canister filter system, the technician must take precautions to not contaminate the filter.

Each filter typically includes a dirty side and a clean side. The unfiltered fluid enters the dirty side of the filter. The filtered fluid leaves the filter from the clean side and enters the fluid system that the filter system protects. If dirt or other contaminants are accidentally put on the dirty side of the filter, in most cases the filter media will trap and collect the dirt or other contaminants before they reach the clean side and enter the fluid system. However, if the dirt or other contaminants are put on the clean side, then they may be free to enter and contaminate the fluid system.

In some canister filter systems, the clean side of the filter media is on the exterior surface of the filter, so the risk of contaminating the fluid system and causing damage is particularly acute if the filter is contaminated prior to installation.

As components such as fuel pumps, hydraulic pumps, engines, etc. become more expensive, more high tech, and are made with tighter tolerances and specifications, it is increasingly important to protect these components against contamination because contamination may cause premature wear and even failure. If canister filter systems are to be used in such applications, then precautions must be taken to ensure that the filter is not contaminated.

### SUMMARY OF THE INVENTION

To help alleviate the risk of contamination of a filter prior to installation, a collapsible protective cover is placed over the filter. The cover is removed during installation of the filter. Other advantages and uses will be apparent to those of ordinary skill in this art.

### BRIEF DESCRIPTION OF THE DRAWINGS

FIGS. 1-11 each show schematically the same filter and protective cover.

FIGS. 1a and 1b illustrate an end cover attached to a protective cover that surrounds a filter.

FIGS. 2a and 2b illustrate the beginning of a process to open the end cover.

FIGS. 3a and 3b illustrate the end cover opened.

FIGS. 4a and 4b illustrate the end cover folded downward and out of the way to permit the filter to engage and enter a canister.

FIG. 5 illustrates the filter positioned for entry into a canister schematically shown in cross section.

FIG. 6 illustrates the filter beginning its entry into the canister and the protective cover beginning to collapse.

FIG. 7 illustrates the filter continuing its entry into the canister with the protective cover continuing to collapse.

FIG. 8 illustrates the filter further continuing its entry into the canister.

FIG. 9 illustrates the filter almost completely inserted into the canister.

FIG. 10 illustrates the filter completely inserted into the canister, and the protective cover removed therefrom.

FIG. 11 illustrates the filter completely inserted into the canister, and the canister closed with an end cap schematically illustrated in cross section.

### DETAILED DESCRIPTION

The following is a detailed description of exemplary embodiments of the invention. The exemplary embodiments described herein and illustrated in the drawing figures are intended to teach the principles of the invention, enabling those of ordinary skill in this art to make and use the invention in many different environments and for many different applications. The exemplary embodiments should not be considered as a limiting description of the scope of patent protection. The scope of patent protection shall be defined by the appended claims.

As discussed above, the ability to protect a filter from dirt and other debris during a filter change can be highly beneficial. To protect the filter, a protective covering may be installed on the filter during manufacturing or at a later stage. The protective covering protects the filter against debris and contamination before installation. During installation, the protective cover is simply and reliably removed in the manner fully described below.

For purposes of illustration, the drawing figures include a filter for a canister filter system which is generally cylindrical in overall shape, as is known in the art, with a radial or circumferential outer surface, and an axial, circular bottom end and top end. The protective cover, too, is generally cylindrical in shape to match the filter, with at least a closed bottom end. The protective cover can be collapsed as the end of the protective cover is drawn or pulled down over the filter, to expose the filter, toward the other end of the protective cover.

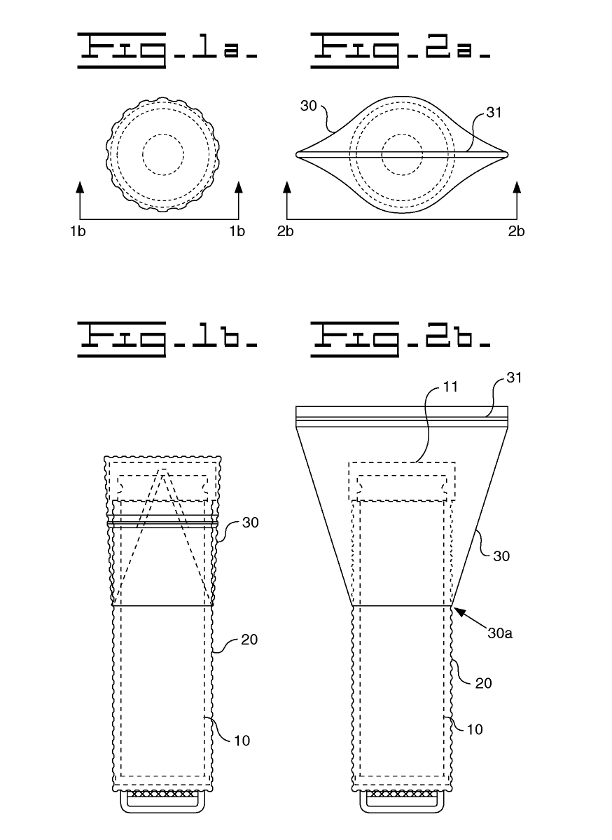

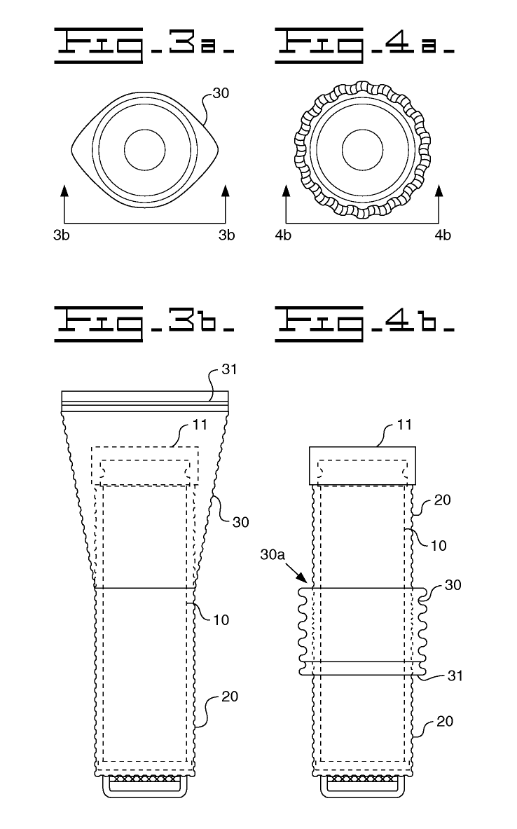

The top end of the protective cover may be closed with an end cover. The end cover is optional. The end cover is initially closed, and can then be opened immediately prior to installation to expose the top end of the filter for insertion into a canister opening. FIGS. 1a, 1b, 2a, 2b, 3a, 3b, 4a, and 4b illustrate a sequence of opening the optional end cover that may be used in conjunction with the protective cover.

In FIGS. 1a and 1b, the filter 10 is covered by the collapsible, protective cover 20. Protective cover 20 may be installed around the filter 10 at the time of manufacture of the filter, or at a later time. Protective cover 20 is intended to protect filter 10 from accidental contamination which may occur before the filter is installed. To be covered, the filter 10 need not be completely sealed from the outside environment. For example, a protective cover 20 which is open at a top end but still covers a majority of the filter element and protects it from contamination, should be considered as covering the filter 10.

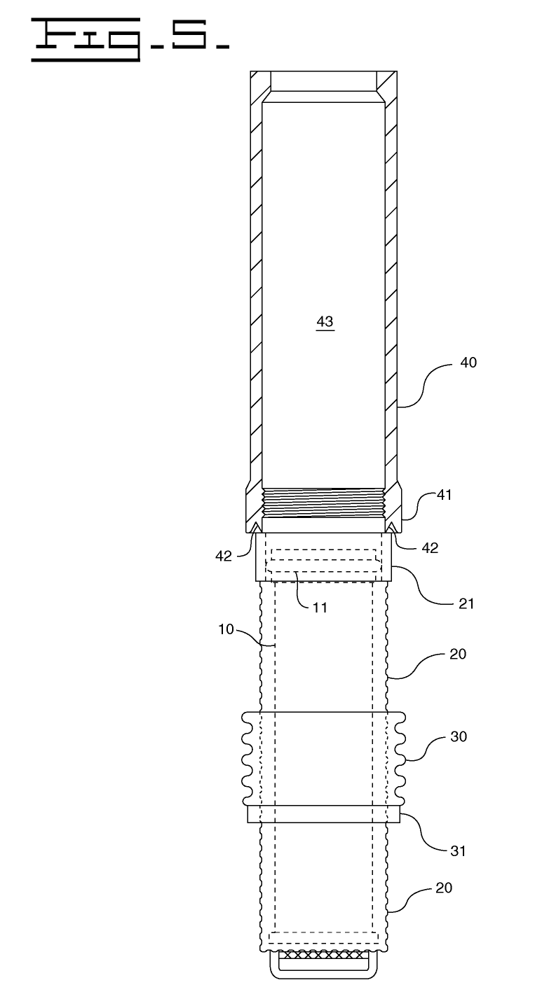

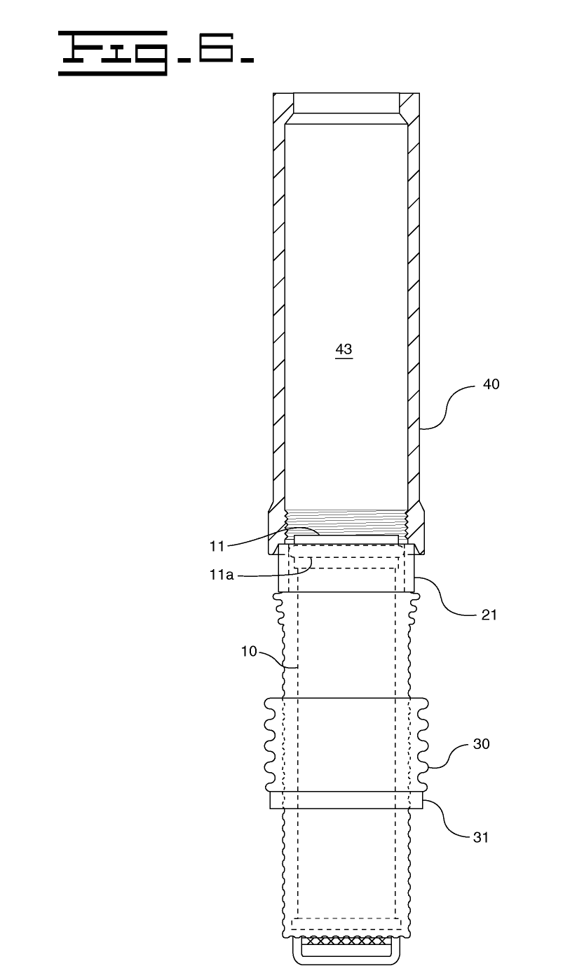

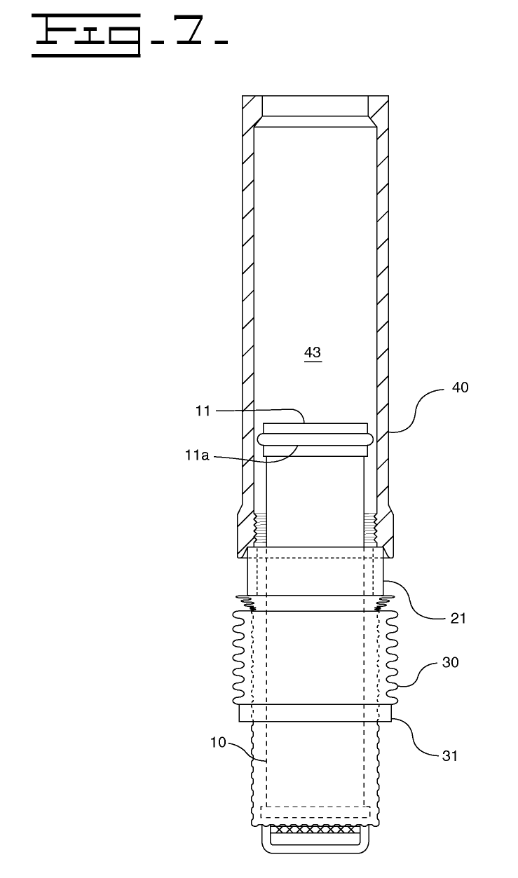

Protective cover 20 in this embodiment includes the optional end cover 30. End cover 30 is attached to protective cover 20 along a circumferential line at 30a. End cover 30 includes a selectively closeable portion 31 which could be a zipper or clasp structure known for closing plastic bags and the like. When closeable portion 31 is closed, it forms, with protective cover 20 and end cover 30, an enclosed chamber which protects dirt and debris from entering into the interior of filter 10 through its axial end 11. End cover 30 may be folded and temporarily affixed to the protective cover 20 during packaging and shipping to keep it out of the way, as illustrated particularly in FIG. 1b. Then, while the technician is preparing the filter for insertion into the canister, the end cover can be extended into the shape shown particularly in FIGS. 2a and 2b. Then the technician can open the closeable portion 31, as shown in FIGS. 3a and 3b. From this point on, the axial end 11 of the filter 10 is exposed to the outside environment. But prior to opening the closeable portion 31, the axial end 11 was sealed and protected from contamination in the outside environment. In FIGS. 4a and 4b, the end cover 30 has been turned inside-out and folded back over the protective cover 20, along line 30a, to keep it out of the way.

The end cover 30 is optional. The protective cover 20 could be constructed without end cover 30, leaving the axial end 11 of the filter more exposed to the environment during shipping and storage. In some applications, this additional exposure may not present a risk. In other applications, a different system other than end cover 30 may be used to temporarily protect the axial end 11 of the filter from exposure. For example, protective cover 20 may be made to completely enclose the filter 10, even around axial end 11. Then, prior to installation, a technician would cut or tear away the portion of protective cover 20 surrounding axial end 11 to prepare for insertion into a canister.

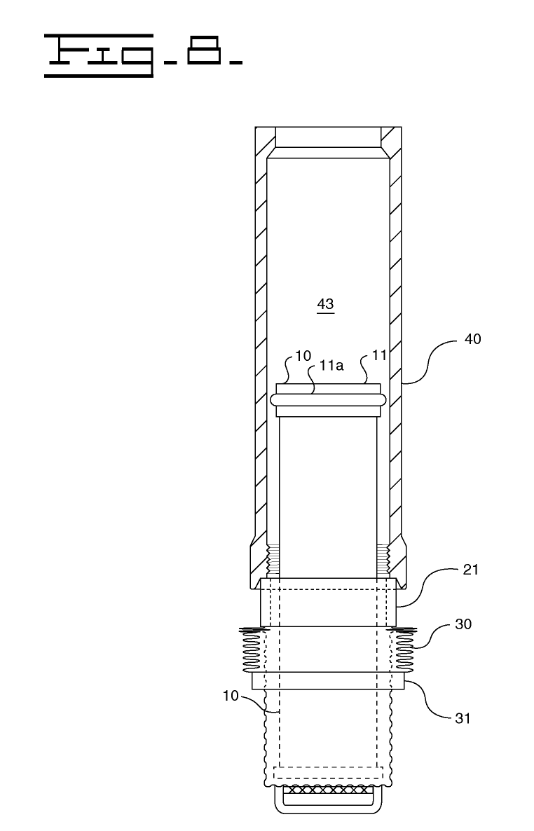

FIG. 5 shows the filter 10 positioned for insertion into a canister 40. The canister 40 can be made according to any of several designs known to those of ordinary skill in this art, or could be made according to a new design for a particular application. The canister 40 may be attachable to a base member (not shown) which is typically attached to the engine or machinery. The canister 40 and base member cooperate to direct the flow of fluid through the installed filter 10. The canister 40 would typically be constructed, for example, of metal or other hard polymer material. The filter 10, protective cover 20, and end cover 30 in FIG. 5 are the same as those pictured in FIGS. 4a and 4b and in the same position. However, the protective cover 20 could also be without end cover 30.

A ring 21 made of relatively rigid material, for example a nylon, ABS, or polypropylene or similar polymer material, is fixed to protective cover 20. The ring 21 could be fixed to protective cover 20 with the aid of an adhesive, a clamp assembly, or any other method appropriate for a particular application. The ring 21 and protective cover 20 may be integrally formed of the same material with the ring 21 being relatively more rigid than protective cover 20 because it is made from a thicker section of the material. The ring could be a complete ring shape, or could be only a segment of a ring. The ring could be attached to the protective cover 20 around its entire periphery or circumference, or attached only a discrete locations. Different applications and types of material used will call for different constructions of ring 21. The ring 21 could be sized so that its interior surface fits snugly against an O-ring 11a fitted around the circumference of filter 10. O-ring 11a will prevent any debris from being able to pass between the ring 21 and axial end 11 and contaminate the circumferential exterior surface of filter 10.

During assembly of the filter 10 into canister 40, ring 21 may be positioned adjacent a mating groove 42 formed circumferentially in an end 41 of canister 40. FIG. 6 shows the filter 10 during a first stage of insertion into the cavity 43 of the canister 40. The groove 42 engages the ring 21 of protective cover 20 and helps hold ring 21 in position and prevents it and protective cover 20 from entering into the cavity 43. As the filter 10 slides into the cavity 43, the protective cover 20 partially collapses. The collapsing of the protective cover 20 can be made possible by constructing it from a thin sheet or film of material such as a polymer, or a metal such as aluminum or tin, or any other material appropriate for a particular application. The exact composition of the protective cover 20 is not critical, and suitable sheet or film material will be readily identifiable by those of ordinary skill in this art. The protective cover 20 could also be constructed with a more rigid material if the material is capable of folding, perhaps accordion style, to collapse upon itself.

Alternatively, ring 21 may not be necessary. Protective cover 20 may include an open end portion with an edge in the place of ring 20, which contacts the canister and causes the protective cover to collapse and compress.

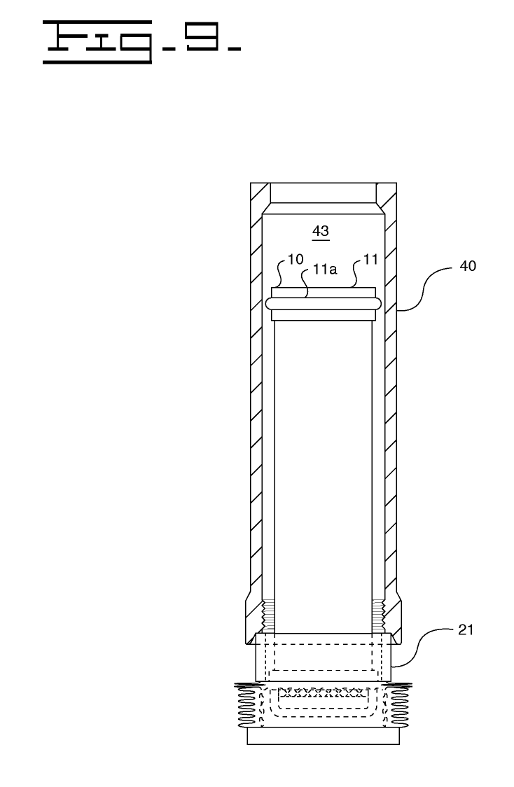

FIG. 7 shows the filter 10 continuing its entry into cavity 43, and protective cover 20 continuing to collapse and compact. Because the material which makes protective cover 20 is not rigid, relatively little force is required to collapse it. Filter 10 can be pushed into cavity 43, while protective cover 20 collapses and compacts, using only the pushing force from a technician's hand. As the protective cover 20 collapses, an increasing portion of filter 10 is outside of the protective cover 20. However, this same portion is now positioned inside of the canister 40 so it is protected from debris.

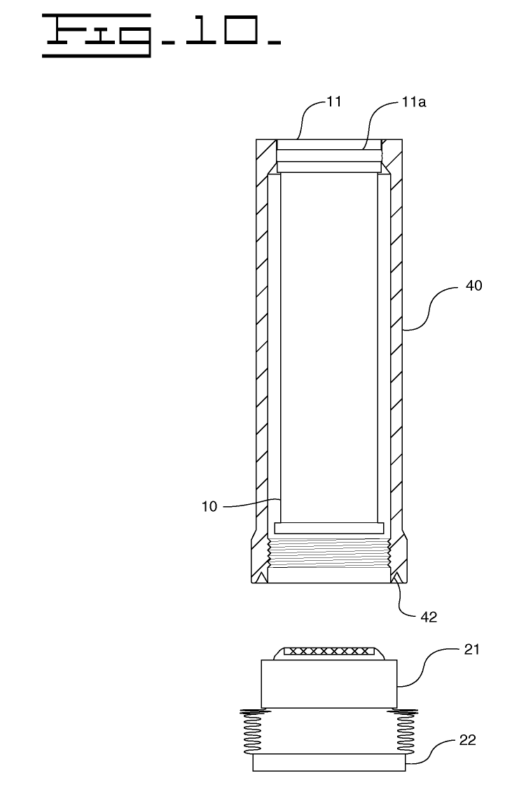

FIGS. 8 and 9 show an increasingly greater portion of filter 10 inside of the canister 40, and an increasingly collapsed and compressed protective cover 20.

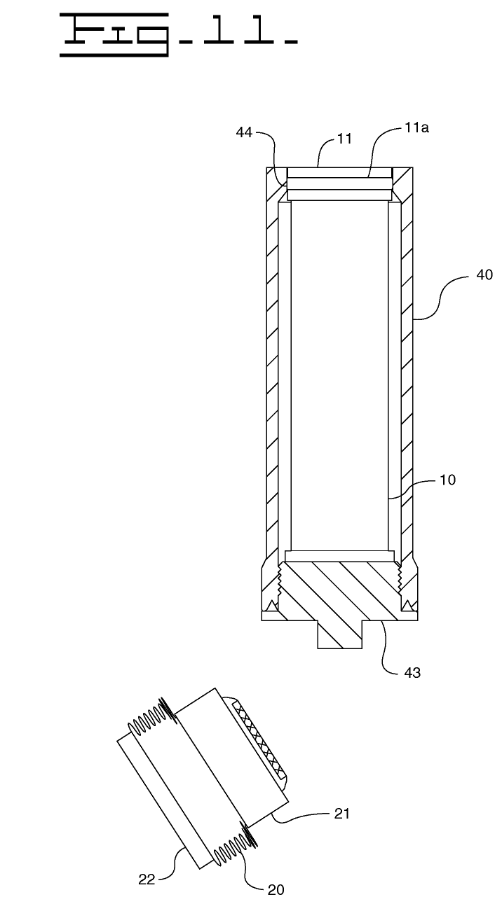

In FIG. 10, the filter is now fully inserted into the canister 40. The O-ring 11a is seated against an opposite end 44 of the canister 40 and helps to define the fluid path that the fluid will take through the filter 10. At or near the time when this occurs, the protective cover 20 can be slipped completely off of the filter 10. A rigid second ring 22 may be provided on the bottom of the protective cover 20 and affixed thereto to help the bottom of protective cover 20 retain its shape and aid in its removal.

In FIG. 11, the canister 40 has been closed with an end cap 43 and the installation of the filter 10 is complete. The used protective cover 20 may be used to enclose and protect a used filter which the new filter 10 replaced. For example, if the used filter were saturated with oil or other potentially hazardous fluid, the protective cover 20 could be used to prevent spills.

### INDUSTRIAL APPLICABILITY

The filter 10 is useful in filtering fluids for applications such as internal combustion engines, construction and mining machinery, and many other types of industrial machinery. Filter 10 may be used to filter contaminants from fluid systems including fuel systems, lubrication oil systems, hydraulic fluid power systems, hydraulic fluid control systems, transmission fluid systems, air intake systems, and the like.

As discussed above, the ability to protect a filter from dirt and other debris during a filter change can be highly beneficial. To protect the filter 10, a protective cover 20 may be installed on the filter 10 during manufacturing or at a later stage. The protective cover 20 protects the filter 10 against debris and contamination before and during installation. During the installation process, the protective cover is simply and reliably removed.

We claim:

1. A process of protecting a filter and then inserting the filter into a canister comprising:
covering the filter in a collapsible protective cover; and
inserting the filter into a canister while simultaneously collapsing the protective cover to expose the portion of the filter that is entering the canister.

2. A process according to claim 1 wherein collapsing the protective cover to expose the portion of the filter that is entering the canister comprises contacting a portion of the protective cover against an end of the canister.

3. A process according to claim 2 wherein collapsing the protective cover to expose the portion of the filter that is entering the canister comprises pushing against the filter and protective cover to exert the force to move the filter into the canister and to collapse the protective cover.

4. A process according to claim 3 wherein the pushing can be done by a technician's hands.

5. A process according to claim 1 wherein collapsing the protective cover to expose the portion of the filter that is entering the canister comprises contacting a ring of the protective cover against an end of the canister.

6. A process according to claim 5 wherein the ring contacts the end of the canister at a groove formed in the end of the canister, the groove sized to accept the ring.

7. A process according to claim 5 wherein covering the filter in a collapsible protective cover comprises contacting an O-ring on the filter against the ring, the contacting sealing against contamination passing between the O-ring of the filter and the ring of the protective covering.

8. A process according to claim 7 wherein inserting the filter into a canister results in contacting the O-ring against the canister to help define a flow path of a fluid in the canister into and out of the filter.

9. A process according to claim 1 wherein before inserting the filter into a canister, an end cover if first opened or removed from the protective cover to expose an axial end of the filter.

10. A process according to claim 9 wherein collapsing the protective cover to expose the portion of the filter that is entering the canister comprises contacting a portion of the protective cover against an end of the canister.

11. A process according to claim 10 wherein collapsing the protective cover to expose the portion of the filter that is entering the canister comprises pushing against the filter and protective cover to exert the force to move the filter into the canister and to collapse the protective cover.

12. A process according to claim 11 wherein the pushing can be done by a technician's hands.

13. A process according to claim 9 wherein collapsing the protective cover to expose the portion of the filter that is entering the canister comprises contacting a ring of the protective cover against an end of the canister.

14. A process according to claim 13 wherein the ring contacts the end of the canister at a groove formed in the end of the canister, the groove sized to accept the ring.

15. A process according to claim 13 wherein covering the filter in a collapsible protective cover comprises contacting an O-ring on the filter against the ring, the contacting sealing against contamination passing between the O-ring of the filter and the ring of the protective covering.

16. A filter assembly comprising:
a filter;
a collapsible protective cover covering the filter; and
means for the protective cover to contact a canister and cause the protective cover to collapse as the filter is inserted into the canister.

17. A filter assembly comprising:
a cylindrical shaped filter with an axial top end and axial bottom end, connected by a circumferential outer surface;
a cylindrical shaped collapsible protective cover covering the filter;
the protective cover constructed from a thin sheet or film of material so that the protective cover may collapse as one end of the protective cover is drawn or pushed down over the filter towards the other end of the protective cover.

18. A filter assembly according to claim 17 further comprising an end cover which covers an open end of the protective cover and includes a closeable portion.

19. A filter assembly according to claim 17 further comprising a ring attached to an end portion of the protective cover, the ring being of a more rigid construction than the protective cover.
